(19) United States
(12) Patent Application Publication
(10) Pub. No.: US 2018/0281685 A1
(43) Pub. Date: Oct. 4, 2018

(54) REAR VIEW MANUAL ADJUSTMENT PERSPECTIVE CHANGE SYSTEM AND METHOD

(71) Applicant: Panasonic Automotive Systems Company of America, Division of Panasonic Corporation of North America, PEACHTREE CITY, GA (US)

(72) Inventor: MICHAEL DEAN TSCHIRHART, ANN ARBOR, MI (US)

(73) Assignee: Panasonic Automotive Systems Company of America, Division of Panasonic Corporation of North America

(21) Appl. No.: 15/942,595

(22) Filed: Apr. 2, 2018

Related U.S. Application Data
(60) Provisional application No. 62/480,612, filed on Apr. 3, 2017.

(51) Int. Cl. B60R 1/12; B60R 1/04

(52) U.S. Cl. CPC B60R 1/12; B60R 1/04; B60R 2300/605; B60R 2300/8046; B60R 2001/1253

(57) ABSTRACT

A motor vehicle includes a display screen viewable by a driver of the motor vehicle. A manually adjustable mount is attached to the display screen and enables a three-dimensional orientation of the display screen to be manually adjusted by the driver. The manually adjustable mount transmits an electronic signal indicative of the three-dimensional orientation of the display screen. A rearview camera captures images of a scene behind the motor vehicle. An electronic processor is communicatively coupled to the display screen, the manually adjustable mount and the rearview camera. The electronic processor determines, based on the electronic signal from the manually adjustable mount, the three-dimensional orientation of the display screen. The electronic processor controls video content presented on the display screen. The video content is based on the images captured by the rearview camera. The controlling of the video content is based on the determined three-dimensional orientation of the display screen.

### CROSS-REFERENCE TO RELATED APPLICATION

This application claims benefit of U.S. Provisional Application No. 62/480,612 filed on Apr. 3, 2017, which the disclosure of which is hereby incorporated by reference in its entirety for all purposes.

### BACKGROUND OF THE INVENTION

### 1. Field of the Invention

The present invention relates to rearview displays in a motor vehicle, and, more particularly, to display-based mirror substitute technologies.

### 2. Description of the Related Art

Display-based mirror substitute technologies like intelligent rearview mirror system (IRMS) enable a range of desirable features and functions to the driver. However, early testing reveals that such systems are off-putting to some users because their use is uncomfortably unnatural compared to the use of traditional mirrors. Most systems of this kind rely on a comparatively clumsy, manual adjustment of image coverage through the use of some button- or screen-based interface.

### SUMMARY OF THE INVENTION

The present invention may provide a more natural and desirable functionality to display-based mirror substitute technologies. The invention may provide display-based alternatives to the traditional rear-view mirror (e.g., IRMS). The invention may combine the manual adjustment of the IRMS display unit with processing capabilities of the IRMS (or related technology) display system to dynamically adjust the gaze perspective to make the experience more naturalistic, as though it behaves like a traditional mirror.

The invention may provide this functionality by using key parts of the display mounting assembly as a kind of joystick/controller to adjust the angle of the rear-facing camera. The driver's manual adjustment inputs are then used to dynamically adjust the perspective of the image presented on the display to emulate the effect of the changing viewable image on a mirror. For instance, as the user changes her head position to one side, as indicated by her manual adjustment of the orientation of the display, the display image is modified to correspond to the viewable area that would be evident with a corresponding change of head position and display orientation using a traditional mirror. For example, the perspective of the image presented on the display may be dynamically adjusted to emulate the effect of the changes in the orientation of the display and in the inferred changes in the user's head position.

In one embodiment, the present invention comprises a motor vehicle having a display screen viewable by a driver of the motor vehicle. A manually adjustable mount is attached to the display screen and enables a three-dimensional orientation of the display screen to be manually adjusted by the driver. The manually adjustable mount transmits an electronic signal indicative of the three-dimensional orientation of the display screen. A rearview camera captures images of a scene behind the motor vehicle. An electronic processor is communicatively coupled to the display screen, the manually adjustable mount and the rearview camera. The electronic processor determines, based on the electronic signal from the manually adjustable mount, the three-dimensional orientation of the display screen. The electronic processor controls video content presented on the display screen. The video content is based on the images captured by the rearview camera. The controlling of the video content is based on the determined three-dimensional orientation of the display screen.

In another embodiment, the present invention comprises a motor vehicle including a display screen viewable by a driver of the motor vehicle. A manually adjustable mount is attached to the display screen and enables a three-dimensional orientation of the display screen to be manually adjusted by the driver. The manually adjustable mount transmits an electronic signal indicative of the three-dimensional orientation of the display screen. A rearview camera captures images of a scene behind the motor vehicle. An electronic processor is communicatively coupled to the display screen, the manually adjustable mount and the rearview camera. The electronic processor determines, based on the electronic signal from the manually adjustable mount, the three-dimensional orientation of the display screen. The electronic processor transmits a video signal to the display screen. The video signal is based on a selected portion of the images captured by the rearview camera. The portion of the images that is selected is dependent upon the determined three-dimensional orientation of the display screen.

In yet another embodiment, the present invention comprises a motor vehicle including a display screen viewable by a driver of the motor vehicle. A manually adjustable mount is attached to the display screen and enables a three-dimensional orientation of the display screen to be manually adjusted by the driver. The manually adjustable mount transmits an electronic signal indicative of the three-dimensional orientation of the display screen. A rearview camera captures images of a scene behind the motor vehicle. An actuator is coupled to the rearview camera and adjusts a three-dimensional orientation of the rearview camera. An electronic processor is communicatively coupled to the display screen, the manually adjustable mount, the actuator, and the rearview camera. The electronic processor determines, based on the electronic signal from the manually adjustable mount, the three-dimensional orientation of the display screen. The electronic processor controls the actuator such that a three-dimensional orientation of the rearview camera corresponds to the determined three-dimensional orientation of the display screen. The electronic processor transmits a video signal to the display screen. The video signal is based on the images captured by the rearview camera.

An advantage of the present invention is that it may dramatically improve natural features of how people want to interact with the technology and further reduce other aspects of product interaction “friction” (e.g., less time, fewer steps, etc.). Thus, the invention may facilitate a more natural and desirable functionality to such systems.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is a block diagram of one embodiment of a rearview display arrangement of the present invention.

FIG. 2A is a frontward view inside a passenger compartment of a motor vehicle including a portion of the rearview display arrangement of FIG. 1.

FIG. 2B is a top view of a rearview camera of the rearview display arrangement of FIG. 1.

FIG. 3 is a plan view of a field of view of the rearview camera of the rearview display arrangement of FIG. 1, and the portion of the field of view that is displayed on the display screen of the rearview display arrangement of FIG. 1.

### DETAILED DESCRIPTION OF DRAWINGS

The embodiments hereinafter disclosed are not intended to be exhaustive or limit the invention to the precise forms disclosed in the following description. Rather the embodiments are chosen and described so that others skilled in the art may utilize its teachings.

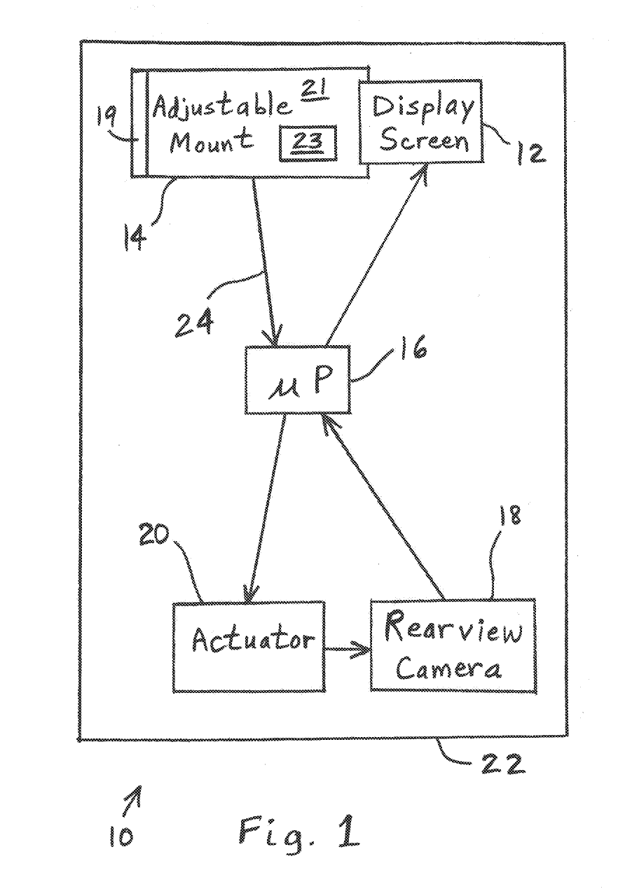

FIG. 1 illustrates one embodiment of a rearview display arrangement 10 of the present invention, including a display screen 12 attached to an adjustable mount 14, an electronic processor 16, a rearview camera 18, and an actuator 20, all of which may be disposed within a same motor vehicle 22. Adjustable mount 14 may be manually adjusted by the driver in order to change the orientation of display screen 12 in three-dimensional space. For example, display screen 12 may have a flat viewable surface, and the driver may change the direction in which the viewable surface faces by manually moving adjustable mount 14 in three-dimensional space. Adjustable mount 14 may include a fixed portion 19 and a pivotable portion 21 that follows the pivoting of display screen 12. Fixed portion 19 and a pivotable portion 21 may be interconnected by a ball and socket joint (not shown), for example. Within pivotable portion 21 of adjustable mount 14 may be one or more sensors 23 (e.g., one or more gyroscopes) that detect the orientation of display screen 12 and transmit to processor 16 signals 24 which are indicative of the three-dimensional orientation of display screen 12.

Rearview camera 18 may be attached to a rear end of vehicle 22, and may capture images of a scene behind vehicle 22. Rearview camera 18 may have a field of view similar to the field of view of a conventional rearview mirror.

Actuator 20, under the control of processor 16, may be capable of pivoting rearview camera 18 both about a vertical axis and about a horizontal axis that is perpendicular to the forward and rearward directions in which vehicle 22 generally travels. Thus, actuator 20 may pivot rearview camera 18 to emulate the driver moving his head both laterally and vertically.

In one embodiment, processor 16 may receive signals 24 transmitted by sensors 23 of adjustable mount 14, change the orientation of rearview camera 18 to correspond to the orientation of display screen 12, and present on display screen 12 a mirror image of each of the images captured by camera 18. A mirror image of the captured image is presented in order to emulate the view that a driver would see in a conventional mirror. The orientation of camera 18 as it captures images the mirror images of which are displayed on screen 12 may vary depending upon the three-dimensional orientation of display screen 12, as determined by processor 16. Processor 16 may determine the orientation of display screen 12 based on signals 24 transmitted by sensors 23 of adjustable mount 14. Although it is possible for display screen 12 to have a generally isosceles trapezoidal shape, as a conventional rearview mirror might, it is also possible for display screen 12 to be rectangular in shape.

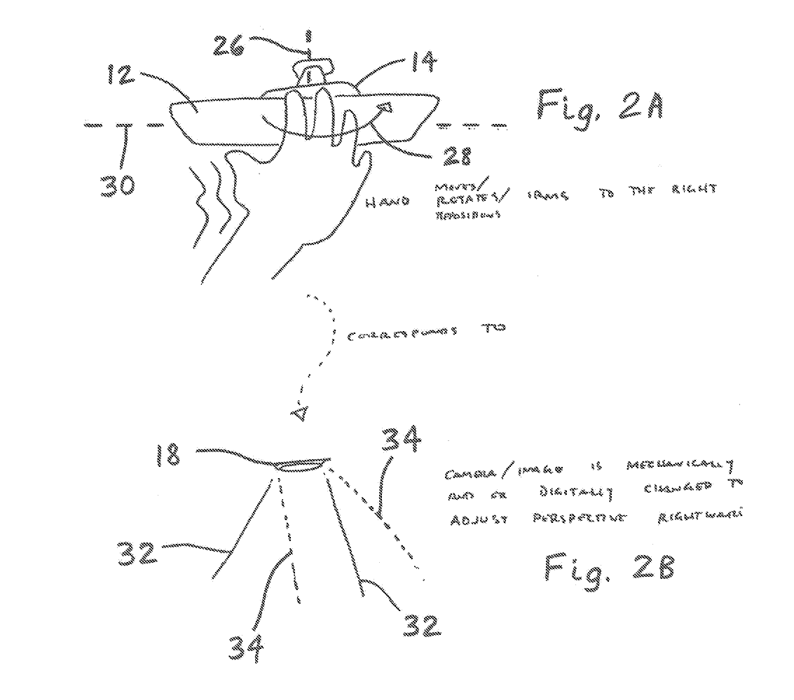

FIG. 2A is a frontward view inside a passenger compartment of motor vehicle 22. Adjustable mount 14 may be attached to the side of display screen 12 that faces away from the driver of vehicle 22. Display screen 12 may be pivotable about a vertical axis 26 in each of two rotational directions, and about a horizontal axis 30 in each of two other rotational directions. One of the two rotational directions in which display screen 12 may be pivoted about vertical axis 26 is indicated by arrow 28, which may be the result of the driver gripping display screen 12 and moving his hand in direction 28.

FIG. 2B is a downward view looking at rearward camera 18. FIG. 2B illustrates the rotation of camera 18, and the resulting changing field of view of camera 18, in response to the driver rotating display screen 12 in rotational direction 28 about axis 26. That is, with display screen 12 in its original or initial position, the field of view of camera 18 is as bounded at 32, and spans about 90 degrees. As the driver rotates display screen 12 in rotational direction 28, the field of view of camera 18 correspondingly rotates to the position as bounded at 34, and still spans about 90 degrees. Consequently, processor 16 may change the portion of the external image that is presented on display screen 12 to emulate the changing field of view provided by a conventional rearview mirror as the driver moves his head.

Although the rotation of camera 18 and its field of view has been shown in one rotational direction, it is to be understood that camera 18 and its field of view may rotate in the opposite rotational direction in response to rotation of display screen 12 in the direction opposite to direction 28. Further, camera 18 and its field of view may rotate upward or downward in response to rotation of display screen 12 upward or downward, respectively.

In another embodiment, instead of actuator 20 reorienting rearview camera 18 in response to rotation of display screen 12, processor 16 may receive the images captured by a stationary rearview camera 18, and present a portion of a mirror image of each of the captured images on display screen 12. A mirror image of the captured image is presented in order to emulate the view that a driver would see in a conventional mirror. The portions of the mirror images of the captured images that are displayed on screen 12 may vary depending upon the three-dimensional orientation of display screen 12, as determined by processor 16. Processor 16 may determine the orientation of display screen 12 based on signals 24 transmitted by sensors 23 of adjustable mount 14.

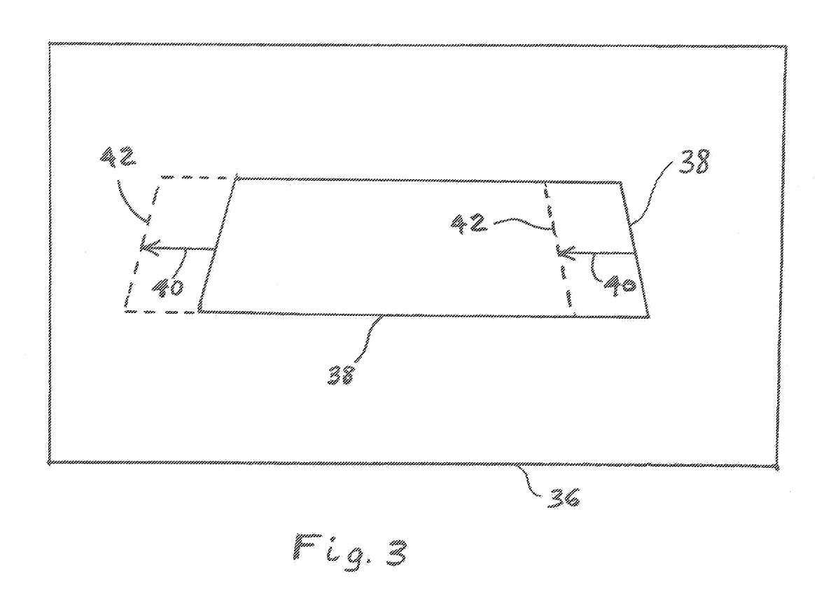

FIG. 3 illustrates a mirror image 36 of a field of view of rearview camera 18, and the portion 38 of the mirror image 36 of the field of view that is displayed on display screen 12. Rearview camera 18 may capture images of the entire field of view 36, but processor 16 may transmit a video signal to display screen 12 that includes only portion 38. The video signal may include mirror images of the actual captured images to emulate the reflection of a conventional mirror.

As the driver rotates display screen 12 in rotational direction 28, processor 16 may shift displayed portion 38 of mirror image 36 of the field of view leftward, as indicated by arrows 40, and by the dashed lines 42 indicating the shifted position of portion 38. The leftward movement of portion 38 in response to the rotation of display screen 12 in direction 28 emulates the changing view that a driver would see in a conventional mirror. Conversely, if the driver were to rotate display screen 12 in the rotational direction opposite to 28, portion 38 would shift rightward. Further, if the driver were to rotate display screen 12 upward, portion 38 would shift upward; and if the driver were to rotate display screen 12 downward, portion 38 would shift downward.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A motor vehicle comprising:
a display screen viewable by a driver of the motor vehicle;
a manually adjustable mount attached to the display screen and configured to:
enable a three-dimensional orientation of the display screen to be manually adjusted by the driver; and
transmit an electronic signal indicative of the three-dimensional orientation of the display screen;
a rearview camera configured to capture images of a scene behind the motor vehicle; and
an electronic processor communicatively coupled to the display screen, the manually adjustable mount and the rearview camera, the electronic processor being configured to:
determine, based on the electronic signal from the manually adjustable mount, the three-dimensional orientation of the display screen; and
control video content presented on the display screen, the video content being based on the images captured by the rearview camera, the controlling being based on the determined three-dimensional orientation of the display screen.

2. The motor vehicle of claim 1, wherein the electronic processor is configured to control the video content presented on the display screen by changing a three-dimensional orientation of the rearview camera.

3. The motor vehicle of claim 2 wherein, in response to the driver rotating the display screen in a counterclockwise direction as viewed from a downward direction, the rearview camera rotates in a counterclockwise direction as viewed from a downward direction.

4. The motor vehicle of claim 2, wherein, in response to the driver changing the orientation of the display screen, the orientation of the rearview camera is changed to emulate a view of the driver in a conventional rearview mirror as an orientation of the rearview mirror is changed.

5. The motor vehicle of claim 1, wherein the electronic processor is configured to control the video content presented on the display screen by transmitting to the display screen a video signal based on a selected portion of the images captured by the rearview camera, the portion of the images that is selected being dependent upon the determined three-dimensional orientation of the display screen.

6. The motor vehicle of claim 1 wherein the display screen is disposed approximately at a midpoint of a top edge of a windshield of the motor vehicle.

7. The motor vehicle of claim 1 wherein the rearview camera is attached to a rear end of the motor vehicle.

8. A motor vehicle comprising:
a display screen viewable by a driver of the motor vehicle;
a manually adjustable mount attached to the display screen and configured to:
enable a three-dimensional orientation of the display screen to be manually adjusted by the driver; and
transmit an electronic signal indicative of the three-dimensional orientation of the display screen;
a rearview camera configured to capture images of a scene behind the motor vehicle; and
an electronic processor communicatively coupled to the display screen, the manually adjustable mount and the rearview camera, the electronic processor being configured to:
determine, based on the electronic signal from the manually adjustable mount, the three-dimensional orientation of the display screen; and
transmit a video signal to the display screen, the video signal being based on a selected portion of the images captured by the rearview camera, the portion of the images that is selected is dependent upon the determined three-dimensional orientation of the display screen.

9. The motor vehicle of claim 8, wherein the video signal represents a selected portion of mirror images of the images captured by the rearview camera, the portion of the mirror images of the images that is selected for representation by the video signal being dependent upon the determined three-dimensional orientation of the display screen.

10. The motor vehicle of claim 9 wherein, in response to the driver rotating the display screen in a counterclockwise direction as viewed in a downward direction, the portion of the mirror images of the images captured by the rearview camera that is selected for representation by the video signal moves in a rightward direction relative to the mirror images of the images.

11. The motor vehicle of claim 10 wherein, in response to the driver rotating the display screen to face in a more downward direction, the portion of the mirror images of the images captured by the rearview camera that is selected for representation by the video signal moves in a downward direction relative to the mirror images of the images.

12. The motor vehicle of claim 8, wherein, in response to the driver rotating the display screen, the portion of the images captured by the rearview camera is selected to emulate a view of the driver in a conventional rearview mirror as the driver rotates the rearview mirror.

13. The motor vehicle of claim 8 wherein the display screen is disposed approximately at a midpoint of a top edge of a windshield of the motor vehicle.

14. The motor vehicle of claim 8 wherein the rearview camera is attached to a rear end of the motor vehicle.

15. A motor vehicle comprising:
a display screen viewable by a driver of the motor vehicle;
a manually adjustable mount attached to the display screen and configured to:
enable a three-dimensional orientation of the display screen to be manually adjusted by the driver; and
transmit an electronic signal indicative of the three-dimensional orientation of the display screen;
a rearview camera configured to capture images of a scene behind the motor vehicle;
an actuator coupled to the rearview camera and configured to adjust a three-dimensional orientation of the rearview camera; and
an electronic processor communicatively coupled to the display screen, the manually adjustable mount, the actuator, and the rearview camera, the electronic processor being configured to:
determine, based on the electronic signal from the manually adjustable mount, the three-dimensional orientation of the display screen;
control the actuator such that a three-dimensional orientation of the rearview camera corresponds to the determined three-dimensional orientation of the display screen; and
transmit a video signal to the display screen, the video signal being based on the images captured by the rearview camera.

16. The motor vehicle of claim 15, wherein, in response to the driver rotating the display screen in a counterclockwise direction as viewed from a downward direction, the actuator rotates the rearview camera in a counterclockwise direction as viewed from a downward direction.

17. The motor vehicle of claim 16 wherein, in response to the driver rotating the display screen to face in a more upward direction, the actuator rotates the rearview camera to face in a more upward direction.

18. The motor vehicle of claim 15, wherein, in response to the driver changing the orientation of the display screen, the actuator changes an orientation of the rearview camera to emulate a view of the driver in a conventional rearview mirror as an orientation of the rearview mirror is changed.

19. The motor vehicle of claim 15 wherein the display screen is disposed approximately at a midpoint of a top edge of a windshield of the motor vehicle.

20. The motor vehicle of claim 15 wherein the rearview camera is attached to a rear end of the motor vehicle.
